(19) United States
(12) Patent Application Publication
(10) Pub. No.: US 2016/0253693 A1
(43) Pub. Date: Sep. 1, 2016

(54) REMUNERATION COMPUTATION DEVICE, REMUNERATION COMPUTATION METHOD, AND REMUNERATION COMPUTATION PROGRAM

(71) Applicant: RAKUTEN, INC., Setagaya-ku ,Tokyo (JP)

(72) Inventors: Masayuki MINASHIMA, Setagaya-ku (JP); Otaka TAKEMASA, Setagaya-ku (JP)

(73) Assignee: Rakuten, Inc., Setagaya-ku, Tokyo (JP)

(21) Appl. No.: 15/030,156

(22) PCT Filed: Jan. 30, 2014
(86) PCT No.: PCT/JP2014/052102

§ 371 Date: Apr. 18, 2016

(51) Int. Cl. G06Q 30/02

(52) U.S. Cl. CPC G06Q 30/0214

(57) ABSTRACT

A remuneration computation device is a device that calculates remuneration to be given to a seller of a product, and it includes an acquisition means for acquiring association information where a seller of a product, the product, an owner of the product, and sales of a related product purchased during a period when the owner owns the product, the related product to be purchased in relation to the product, are associated, a calculation means for calculating remuneration to be given to a seller of the product based on sales associated with at least some of a plurality of owners after the product is sold including a person who has purchased the product from the seller and a person to whom the product has been transferred, and an output means for outputting remuneration information containing information about the remuneration.

### TECHNICAL FIELD

One aspect of the present invention relates to a remuneration computation device, a remuneration computation method, and a remuneration computation program.

### BACKGROUND ART

Currently, remuneration for the sales of a product is paid from a manufacturer or the like to a seller in order to promote the sales of the product by the seller. Further, a system that is configured to be able to provide a terminal device with information about a product or the like of a seller by prompting the terminal device related to the product sold to connect to the seller's server is known (see Patent Literature 1, for example). In this system, by providing information about a product or the like of a seller, expectations on the promotion of the sales of the seller's product or the like act as an incentive to the seller to sell the terminal device.

### CITATION LIST

### Patent Literature

PTL 1: Japanese Unexamined Patent Publication No. 2013-125381

### SUMMARY OF INVENTION

### Technical Problem

There are two types of products: products on one-time sale and products on continuous sale. While the selling of a product on one-time sale comes to an end when that product is sold, even after a product on continuous sale is sold, the selling of a related product to that product continues by a manufacturer or the like.

However, according to related art, the system that promotes the sales of products is the same for any type of products. In general, the selling price of a product on continuous sale is low by its earnings model, and therefore remuneration is relatively low. Thus, the system according to related art is not necessarily effective for products on continuous sale while it is effective for products on one-time sale.

Further, although there is a case where a product is transferred to another person or a plurality of products (for example, a new model and an old model) are owned by one person, the system according to related art gives no consideration about the transferring or the owning of a plurality of products. Further, despite that the product use status differs from owner to owner, the system according to related art gives no consideration about the difference in use status.

Note that to “transfer” means to have a product currently under possession of one person placed under possession of another person. Further, to “own” means the state where someone is exclusively associated with a product under his/her possession by activating the product.

In light of the above, an object of one aspect of the present invention is to provide a system that can promote the sales of products including products on continuous sale.

### Solution to Problem

To solve the above problem, a remuneration computation device according to one aspect of the present invention is a remuneration computation device for calculating remuneration to be given to a seller of a product, the device including an acquisition means for acquiring association information where a seller of a product, the product, an owner of the product, and sales of a related product purchased during a period when the owner owns the product, the related product to be purchased in relation to the product, are associated, a calculation means for calculating remuneration to be given to a seller of the product based on sales associated with at least some of a plurality of owners after the product is sold including a person who has purchased the product from the seller and a person to whom the product has been transferred, and an output means for outputting remuneration information containing information about the remuneration.

A remuneration computation method according to one aspect of the present invention is a remuneration computation method in a remuneration computation device for calculating remuneration to be given to a seller of a product, the method including an acquisition step of acquiring association information where a seller of a product, the product, an owner of the product, and sales of a related product purchased during a period when the owner owns the product, the related product to be purchased in relation to the product, are associated, a calculation step of calculating remuneration to be given to a seller of the product based on sales associated with at least some of a plurality of owners after the product is sold including a person who has purchased the product from the seller and a person to whom the product has been transferred, and an output step of outputting remuneration information containing information about the remuneration.

A remuneration computation program according to one aspect of the present invention causes a computer to function as a remuneration computation device for calculating remuneration to be given to a seller of a product, the program causing the computer to implement an acquisition function that acquires association information where a seller of a product, the product, an owner of the product, and sales of a related product purchased during a period when the owner owns the product, the related product to be purchased in relation to the product, are associated, a calculation function that calculates remuneration to be given to a seller of the product based on sales associated with at least some of a plurality of owners after the product is sold including a person who has purchased the product from the seller and a person to whom the product has been transferred, and an output function that outputs remuneration information containing information about the remuneration.

According to the above aspects, based on the sales of related products purchased by at least some of owners after the product is sold, remuneration to a seller of the product is calculated. Then, the calculated remuneration can be paid to the seller as promotion money. Thus, the promotion money acts as an incentive for the sales of the product by the seller, and it is thus possible to promote the sales of the product.

In the remuneration computation device according another aspect, the acquisition means may acquire seller information where the product and a seller of the product are associated, owner information where the product and an owner of the product are associated, and sales information where an owner and sales of a related product purchased by the owner are associated, and generate the association information based on the acquired seller information, owner information and sales information.

According to the above aspect, the association of each of products, sellers, owners and sales can be managed individually. Because those information are associated with one another, remuneration can be calculated easily.

In the remuneration computation device according another aspect, in calculation of the remuneration on the basis of the sales, the calculation means may reduce a proportion of the remuneration to the sales in accordance with the number of transfers of the product at purchase or transfer of the product.

According to the above aspect, because the amount reduced in accordance with the number of transfers of the product can be set as remuneration, it is possible to give adequate amount in accordance with the contribution to the sales of related products as remuneration to the seller.

In the remuneration computation device according another aspect, in calculation of the remuneration on the basis of the sales, when another product different from the product is owned, the calculation means may calculate, as the remuneration, individual remuneration to be given to a seller of the product based on entire remuneration on the basis of the sales.

According to the above aspect, even when an owner of a product owns a plurality of products, individual remuneration can be paid to each seller of the plurality of products as promotion money. Thus, the promotion money acts as an incentive for the sales of the product by the seller, and it is thus possible to promote the sales of the product.

To solve the above problem, a remuneration computation device according to one aspect of the present invention is a remuneration computation device for calculating remuneration to be given to a seller of a product, the device including an acquisition means for acquiring association information where a seller of a product, the product, an owner of the product, and sales of a related product purchased during a period when the owner owns the product, the related product to be purchased in relation to the product, are associated, a calculation means for calculating individual remuneration to be given to a seller associated with at least some of a plurality of products based on entire remuneration on the basis of sales of a related product purchased during a period when one owner owns a plurality of products, the sales being associated with the one owner, and an output means for outputting remuneration information containing information about the individual remuneration.

A remuneration computation method according to one aspect of the present invention is a remuneration computation method in a remuneration computation device for calculating remuneration to be given to a seller of a product, the method including an acquisition step of acquiring association information where a seller of a product, the product, an owner of the product, and sales of a related product purchased during a period when the owner owns the product, the related product to be purchased in relation to the product, are associated, a calculation step of calculating individual remuneration to be given to a seller associated with at least some of a plurality of products based on entire remuneration on the basis of sales of a related product purchased during a period when one owner owns a plurality of products, the sales being associated with the one owner, and an output step of outputting remuneration information containing information about the individual remuneration.

A remuneration computation program according to one aspect of the present invention causes a computer to function as a remuneration computation device for calculating remuneration to be given to a seller of a product, the program causing the computer to implement an acquisition function that acquires association information where a seller of a product, the product, an owner of the product, and sales of a related product purchased during a period when the owner owns the product, the related product to be purchased in relation to the product, are associated, a calculation function that calculates individual remuneration to be given to a seller associated with at least some of a plurality of products based on entire remuneration on the basis of sales of a related product purchased during a period when one owner owns a plurality of products, the sales being associated with the one owner, and an output function that outputs remuneration information containing information about the individual remuneration.

According to the above aspects, based on the sales of related products purchased during a period when an owner owns a plurality of products, individual remuneration to a seller of each of the products is calculated. Then, the calculated individual remuneration can be paid to each seller as promotion money. Thus, the promotion money acts as an incentive for the sales of the product by each seller, and it is thus possible to promote the sales of the product.

In the remuneration computation device according another aspect, he acquisition means may acquire seller information where the product and a seller of the product are associated, owner information where the product and an owner of the product are associated, and sales information where an owner and sales of a related product purchased by the owner are associated, and generate the association information based on the acquired seller information, owner information and sales information.

According to the above aspect, the association of each of products, sellers, owners and sales can be managed individually. Because those information are associated with one another, remuneration can be calculated easily.

In the remuneration computation device according another aspect, the calculation means may calculate the individual remuneration based on use status of the at least some of products.

According to the above aspect, because the individual remuneration to each seller is calculated in accordance with the use status of a plurality of products, it is possible to adjust the remuneration to sellers of the plurality of products to reasonable values in view of the contribution of each of the sellers.

In the remuneration computation device according another aspect, the use status of the product may be a cumulative time when the product is used.

According to the above aspect, because the individual remuneration is calculated based on the cumulative time when each product is used indicating the use status of a plurality of products, adequate individual remuneration to each of sellers of the plurality of terminals is calculated.

In the remuneration computation device according another aspect, the use status of the product may be the number of related products stored in each of the products.

According to the above aspect, because the individual remuneration is calculated based on the number of related products stored in each product indicating the use status of a plurality of products, adequate individual remuneration to each of sellers of the plurality of terminals is calculated.

In the remuneration computation device according another aspect, the use status of the product may be a total price of related products stored in the product.

According to the above aspect, because the individual remuneration is calculated based on the total price of related products stored in each product indicating the use status of a plurality of products, adequate individual remuneration to each of sellers of the plurality of terminals is calculated.

In the remuneration computation device according another aspect, in calculation of the individual remuneration on the basis of the sales, the calculation means may reduce a proportion of the individual remuneration to the sales in accordance with the number of transfers of the product at purchase or transfer of the product related to the individual remuneration.

According to the above aspect, because the amount reduced in accordance with the number of transfers of the product can be set as individual remuneration to each seller, it is possible to give adequate amount in accordance with the contribution to the sales of related products as remuneration to the seller.

### Advantageous Effects of Invention

According to one aspect of the present invention, it is possible to provide a system that can promote the sales of products including products on continuous sale.

### BRIEF DESCRIPTION OF DRAWINGS

FIG. 1 is a view showing a configuration of a system including a remuneration computation device.

FIG. 2 is a block diagram showing a functional configuration of the remuneration computation device.

FIG. 3 is a view showing a hardware configuration of the remuneration computation device.

FIG. 4(a) is a view showing a structure of a seller information storage unit and an example of data stored therein, FIG. 4(b) is a view showing a structure of an owner information storage unit and an example of data stored therein, and FIG. 4(c) is a view showing a structure of a sales information storage unit and an example of data stored therein.

FIG. 5 is a view showing a structure of association information and an example of data stored therein.

FIG. 6 is a view showing an example of calculation of remuneration to a seller.

FIG. 7 is a view showing an example of calculation of remuneration to a seller.

FIG. 8 is a view showing an example of calculation of remuneration to a seller.

FIG. 9 is a view showing an example of calculation of remuneration to a seller.

FIG. 10 is a view showing an example of calculation of remuneration to a seller.

FIG. 11 is a flowchart showing an example of a process of a remuneration computation method.

FIG. 12 is a view showing a structure of association information and an example of data stored therein.

FIG. 13 is a view showing an example of calculation of individual remuneration to a seller.

FIG. 14 is a view showing an example of calculation of individual remuneration to a seller.

FIG. 15 is a view showing an example of calculation of individual remuneration to a seller.

FIG. 16 is a view showing an example of calculation of individual remuneration to a seller.

FIG. 17 is a view showing an example of calculation of individual remuneration to a seller.

FIG. 18 is a view showing an example of calculation of individual remuneration to a seller.

FIG. 19 is a flowchart showing an example of a process of a remuneration computation method.

FIG. 20 is a view showing a structure of a remuneration computation program.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

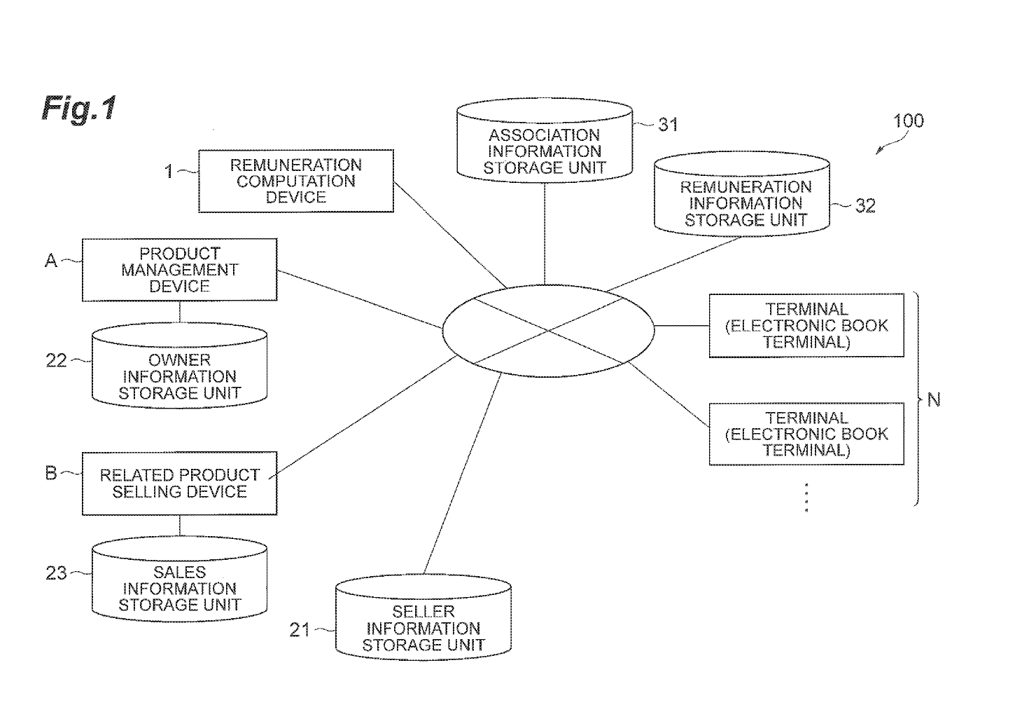

FIG. 1 is a view showing a configuration of a remuneration computation system 100 that includes a remuneration computation device 1 according to this embodiment. As shown in FIG. 1, the remuneration computation system 100 includes a remuneration computation device 1, a product management device A, a related product selling device B, and a terminal (electronic book terminal) N. The remuneration computation device 1 is a device that calculates remuneration to be given a seller of a product based on the sales of a related product that is purchased by an owner of a product associated with a product in relation to that product.

The remuneration computation device 1, the product management device A, the related product selling device B and the terminal N are connected with one another through a network. The product management device A can access an owner information storage unit 22. The related product selling device B can access a sales information storage unit 23. The seller information storage unit 21 can be accessed from a network. Note that, although the case where the owner information storage unit 22 and the sales information storage unit 23 are connected to the network via the product management device A and the related product selling device B, respectively, is shown in this figure, the remuneration computation device 1 may be able to directly access the owner information storage unit 22 and the sales information storage unit 23 via the network. Further, the remuneration computation device 1 can access an association information storage unit 31 and a remuneration information storage unit 32. Although two terminals N are shown in FIG. 1, the number of terminals N is not limited.

A product in this embodiment is the one that is sold to a user and owned by the user, and it is an electronic book terminal, for example. Besides, examples of a product include a game terminal, a video playback terminal, a mobile/fixed telephone, a portable terminal, a television/radio and the like. Further, a product is transferred to another user, or a plurality of products (for example, a new model and an old model) are owned by one user in some cases.

A related product in this embodiment is the one that is used or provided through a product, and it is an electronic book in the case where a product is an electronic book terminal, for example. Besides, examples of a related product for a product include game software for a game terminal, video software (including video stream) for a video playback terminal, voice call for a mobile/fixed telephone, data communication for a portable terminal, satellite/wire broadcasting for a television/radio and the like. Further, a related product may be the one that is finally used or provided in a product, and it may be sold through the product or sold through a market different from the product.

A product is sold by a seller. A user to whom a product is sold can become the owner of the product. In other words, the “owner” of a product is a user to whom the product is sold or transferred and who has activated the product. Further, a product can be transferred to another user. In this embodiment, the case where an electronic book terminal is a product and an electronic book is a related product as shown in FIG. 1 is described as an example. Further, in the following description, an electronic book terminal which is a product is referred to as “terminal”. The type of a device that serves as the terminal N is not limited, and it may be a stationary or portable personal computer, a mobile terminal such as an advanced mobile phone (smart phone), a cellular phone or a personal digital assistant (PDA), or a dedicated terminal device, for example.

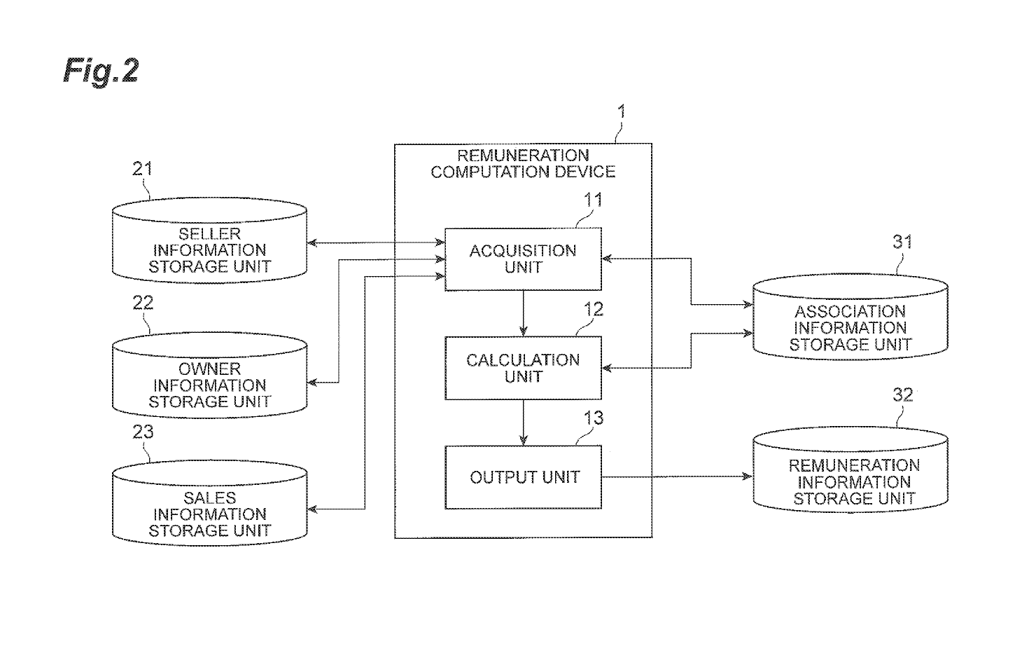

FIG. 2 is a block diagram showing a functional configuration of the remuneration computation device 1 according to this embodiment. As shown in FIG. 2, the remuneration computation device 1 according to this embodiment functionally includes an acquisition unit 11 (acquisition means), a calculation unit 12 (computation means), and an output unit 13 (output means). Further, the functional units 11 to 13 of the remuneration computation device 1 can access the seller information storage unit 21, the owner information storage unit 22, the sales information storage unit 23, the association information storage unit 31 and the remuneration information storage unit 32.

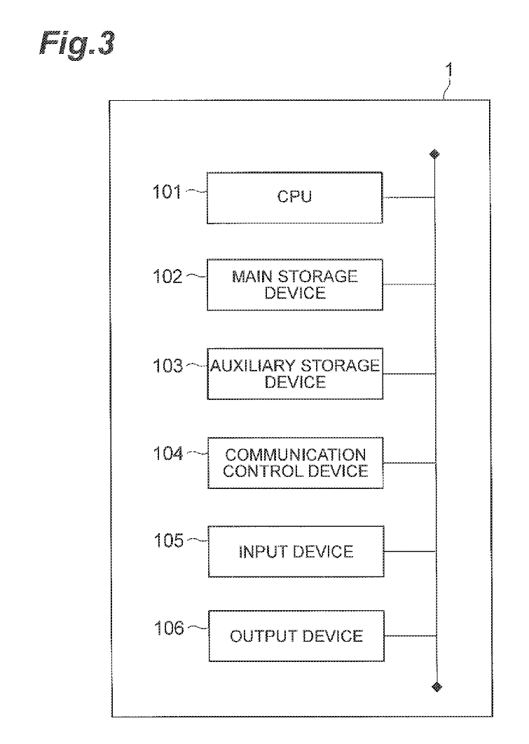

FIG. 3 is a view showing a hardware configuration of the remuneration computation device 1. As shown in FIG. 3, the remuneration computation device 1 is physically configured as a computer system that includes a CPU 101, a main storage device 102 such as memory like RAM and ROM, an auxiliary storage device 103 such as a hard disk, a communication control device 104 such as a network card, an input device 105 such as a keyboard and a mouse, an output device 106 such as a display and the like.

The functions shown in FIG. 2 are implemented by loading given computer software (remuneration computation program) onto hardware such as the CPU 101 or the main storage device 102 shown in FIG. 3, making the communication control device 104, the input device 105 and the output device 106 operate under control of the CPU 101, and performing reading and writing of data in the main storage device 102 or the auxiliary storage device 103. Data and database required for the processing is stored in the main storage device 102 or the auxiliary storage device 103.

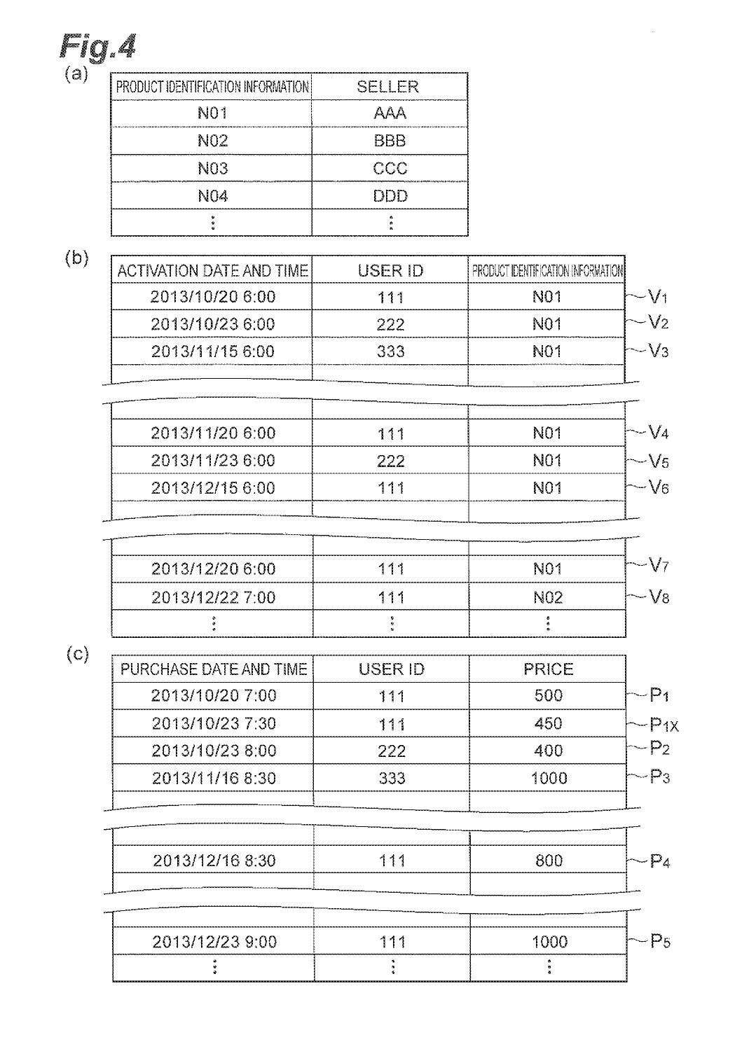

Prior to describing the functional units of the remuneration computation device 1, the seller information storage unit 21, the owner information storage unit 22, the sales information storage unit 23, the association information storage unit 31 and the remuneration information storage unit 32 are described. FIG. 4 shows schematic views of those storage units, and FIG. 4(a) shows a structure of the seller information storage unit 21 and an example of data stored therein, FIG. 4(b) shows a structure of the owner information storage unit 22 and an example of data stored therein, and FIG. 4(c) shows a structure of the sales information storage unit 23 and an example of data stored therein.

The seller information storage unit 21 is a storage means for storing seller information in which a product and a seller of the product are associated with each other. As shown in FIG. 4(a), the seller information storage unit 21 stores product identification information that identifies the terminal N (electronic book terminal), which is a product, and a seller in association with each other. For example, information indicating that the terminal N that is identified by the product identification information “N01” is soled by the seller “AAA” is stored. Association of the seller information may be registered when a manufacturer, an agent and the like of a product sell the product wholesale to a seller, for example.

The owner information storage unit 22 is a storage means for storing owner information in which a product and a user (owner) who owns the product are associated with each other. As shown in FIG. 4(b), the owner information storage unit 22 stores product identification information that identifies the terminal N, a user ID that identifies an owner who owns the terminal N, and activation date and time when the owner has activated the terminal N in association with one another. The product management device A is a device that manages the terminal N, which is a product, and when the terminal N is activated, the product management device A acquires information about the activation and stores it into the owner information storage unit 22. Specifically, when a user who has purchased the terminal N activates the terminal, information about the activation is sent to the product management device A, a user ID that identifies the user who has purchased the terminal N is associated as the owner of the terminal with the terminal N, and this information is stored into the owner information storage unit 22. For example, the owner information storage unit 22 stores information indicating that a user who is identified by the user ID “111” has activated the terminal N that is identified by the product identification information “N01” on “2013/10/20 6:00”. When the activation of the terminal N is done, the owner of the terminal N becomes able to purchase an electronic book, which is a related art, through the terminal N. Note that the user is also able to purchase an electronic book through another terminal or the like without through the terminal N.

The sales information storage unit 23 is a storage means for storing sales information in which the sales of an electronic book, which is a related art, purchased by a user and the user who has purchased it are associated with each other. As shown in FIG. 4(c), the sales information storage unit 23 stores a price, which is the sales of a purchased electronic book, a user who has purchased the electronic book, and purchase date and time when the electronic book is purchased in association with one another. The related product selling device B is a device for constituting an electronic commerce site that sells electronic books, and when an electronic book is purchased in the electronic commerce site, the related product selling device B stores information about the sales into the sales information storage unit 23. For example, the sales information storage unit 23 stores information indicating that a user who is identified by the user ID “111” has purchased an electronic book with the price “500” on “2013/10/20 7:00”.

The association information storage unit 31 is a storage means for storing association information in which the seller information storage unit 21, the owner information storage unit 22 and the sales information storage unit 23 are associated with one another. The remuneration information storage unit 32 is a storage means for storing remuneration information that is output from the output unit 13. The association information storage unit 31 and the remuneration information storage unit 32 are described in detail later.

Next, the functional units of the remuneration computation device 1 are described hereinafter. The acquisition unit 11 is a part that acquires the sales information in which the sales of an electronic book purchased by a user and the user who has purchased the electronic book are associated with each another and the seller information in which the terminal N and a seller of the terminal N are associated with each other. To be specific, the acquisition unit 11 refers to the sales information storage unit 23 and acquires the sales information in which sales and a user are associated with each other.

Note that, in order to recognize which terminal is activated and owned in the period during which the purchase of an electronic book in the acquired sales information is done, the acquisition unit 11 acquires the owner information in the owner information storage unit 22. For example, in the example shown in FIG. 4(b), the acquisition unit 11 can recognize that the owner with the user ID “111” has activated the terminal with the product identification information “N01” on “2013/10/20 6:00”, and the owner with the user ID “222” has activated the terminal with the product identification information “N01” on “2013/10/23 6:00”.

For example, when referring to the sales information P₁ in FIG. 4(c), it is found that the user with the user ID “111” has purchased the electronic book with the price “500” on the purchase data and time “2013/10/20 7:00”. Because this purchase data and time is later than the activation date and time of the owner information V₁ and earlier than the activation date and time of the owner information V₂, the acquisition unit 11 can recognize that electronic book indicated by the sales information P₁ is purchased during the period when the user with the user ID “111” owns the terminal with the product identification information “N01”.

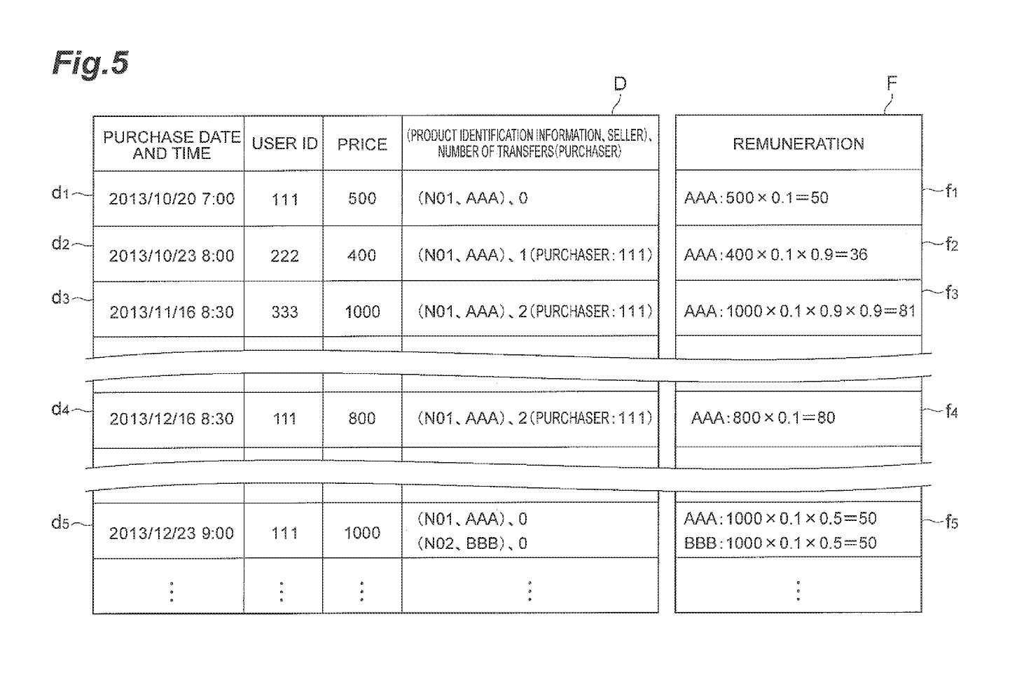

Further, the acquisition unit 11 may acquire the owner information, the sales information and the seller information and perform the processing of generating the association information in which the sales of a related product purchased during a period when an owner owns a product, the owner who has purchased the related product, the product, and a seller of the product are associated with one another. Then, the acquisition unit 11 may store the association information D into the association information storage unit 31. FIG. 5 is a view showing a structure of the association information D, an example of data, and remuneration information F calculated based on the association information D. As shown in FIG. 5, the association information storage unit 31 stores purchase data and time related to sales information of an electronic book, a user ID, a price, product identification information of a terminal owned by the user identified by the user ID at the purchase of the electronic book and identification of a seller who has sold the terminal in association with one another. Note that the remuneration information F is described later.

The generation of the association information D by the acquisition unit 11 is specifically described below. The acquisition unit 11 first acquires one sales information from the sales information storage unit 23 (see FIG. 4(c)), and based on the user ID and he purchase date and time in the sales information, specifies the product identification information of the terminal owned by the user identified by the user ID at the time indicated by the purchase data and time by referring to the owner information (see FIG. 4(b)). Further, the acquisition unit 11 specifies the seller who has sold the terminal with the specified product identification information by referring to the seller information. Then, the acquisition unit 11 stores the sales information in which the specified product identification information and the seller information are associated with each other as the association information into the association information storage unit 31.

For example, because the purchase data and time “2013/10/20 7:00” in the sales information P₁ is after “2013/10/20 6:00” when the user with the user ID “111” has activated the terminal with the product identification information “N01” and before “2013/10/23 6:00” when this terminal is activated by the user with the user ID “222” as shown in the owner information V₁ and V₂, the acquisition unit 11 specifies that the user with the user ID “111” has owned the terminal with the product identification information “N01” at the purchase of the electronic book. Further, the acquisition unit 11 specifies the seller “AAA” associated with the product identification information “N01” by referring to the seller information. Then, the acquisition unit 11 generates association information d₁ in which the specified information (the product identification information “N01” and the seller “AAA”) are associated with the sales information P₁ and stores it into the association information storage unit 31.

Note that the purchase data and time “2013/10/20 7:30” in the sales information P₁ₓ is after “2013/10/20 6:00” when the terminal with the product identification information “N01” is activated by the user with the user ID “222” as shown in the owner information V₂, the acquisition unit 11 can specify that the purchase of the electronic book indicated by the sales information P₁ₓ is done when the user with the user ID “111” does not own the terminal. In other words, it is specified that the purchase of the electronic book indicated by the sales information P₁ₓ is done through a device different from the electronic book terminal N.

Note that, in FIGS. 4(b), 4(c) and 5, the information separated by a cut off line is not time series data but is represented in one table for the sake of convenience of explanation, and they are separate examples.

Likewise, the acquisition unit 11 specifies that the product identification information of the terminal owned by the user with the user ID “222” at the purchase data and time in the sales information P₂ and its seller are “N01” and “AAA”, respectively, by referring to the owner information V₂ and V₃ and the seller information, and then generates association information d₂. Note that, in the case where the user “222” owns the terminal “N01” not by purchase from a seller but by transfer, information such as the number of transfers “1” and the user ID “111” of the user who has purchased the terminal “N01” from a seller may be further associated.

Further, the acquisition unit 11 specifies that the product identification information of the terminal owned by the user with the user ID “333” at the purchase data and time in the sales information P₃ and its seller are “N01” and “AAA”, respectively, by referring to the owner information V₃ and the seller information, and then generates association information d₃. Note that, because the user “333” is a user who owns the terminal “N01” by transfer, information such as the number of transfers “2” and the user ID “111” of the user who has purchased the terminal “N01” from a seller is further associated.

Further, the acquisition unit 11 specifies that the product identification information of the terminal owned by the user with the user ID “111” at the purchase data and time in the sales information P₄ and its seller are “N01” and “AAA”, respectively, by referring to the owner information V₆ and the seller information and then generates association information d₄. Note that, because the acquisition of the terminal “N01” by the user “111” at this time is done by transfer, information indicating the number of transfers “2” is associated based on the owner information V₂, V₅ and V₆. Further, because the terminal “N01” has been purchased from a seller by the user “111” and then transferred to the user “222” and further transferred to the user “111”, information such as the user ID “111” of the user who has purchased the terminal “N01” from the seller is further associated.

Further, the acquisition unit 11 specifies that the terminal owned by the user with the user ID “111” at the purchase data and time in the sales information P₅ is “N01” and “N02”, which are two terminals, based on the owner information V₇ and V₈, and specifies that the sellers of those terminals are “AAA” and “BBB”, respectively. Then, the acquisition unit 11 generates association information d₅ based on the specified information.

The calculation unit 12, which is described later, may calculate remuneration to a seller based on each information of the seller information, the owner information and the sales information acquired by the acquisition unit 11 or may calculate remuneration to a seller by referring to the association information D. The calculation of remuneration becomes easy by referring to the association information storage unit 31.

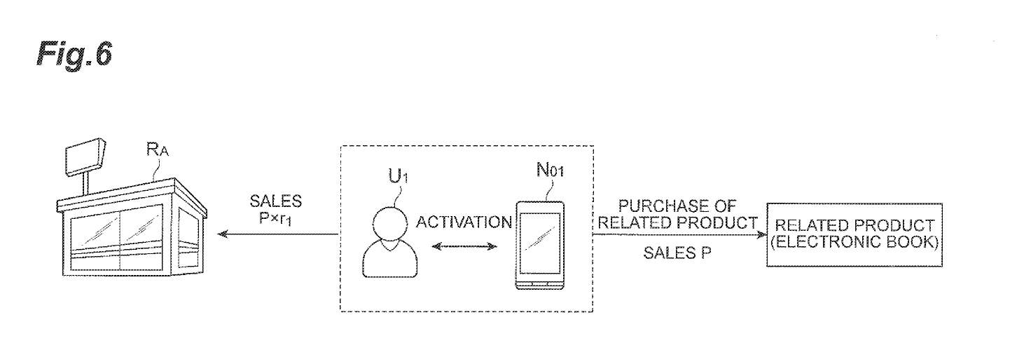

The calculation unit 12 is a part that calculates remuneration to be given to a seller of a terminal based on the sales associated with at least some of a plurality of owners after the selling of the terminal including a person who has purchased the terminal from a seller and a person to whom the terminal has been transferred. The calculation of remuneration is specifically described hereinafter with reference to FIGS. 6 to 10.

FIG. 6 is a view showing an example of the calculation of remuneration based on sales P of electronic books purchased by a user U₁ who has purchased a terminal N₀₁ from a seller R_{A}, activated the terminal N₀₁ and owns the terminal N₀₁. This example corresponds to the association information d₁ in FIG. 5. In the case shown in FIG. 6, the calculation unit 12 multiplies the sales P by a specified coefficient r₁ to calculate remuneration “sales P×r₁” as remuneration to the seller R_{A} of the terminal N₀₁. The coefficient r₁ can be 0.1, for example. Specifically, based on the association information d₁, the calculation unit 12 calculates remuneration “50” to the seller “AAA” as shown in remuneration information f₁. The remuneration in accordance with the contribution of the seller R_{A} to the sales by the purchase of the electronic book by the owner U₁ is thereby calculated.

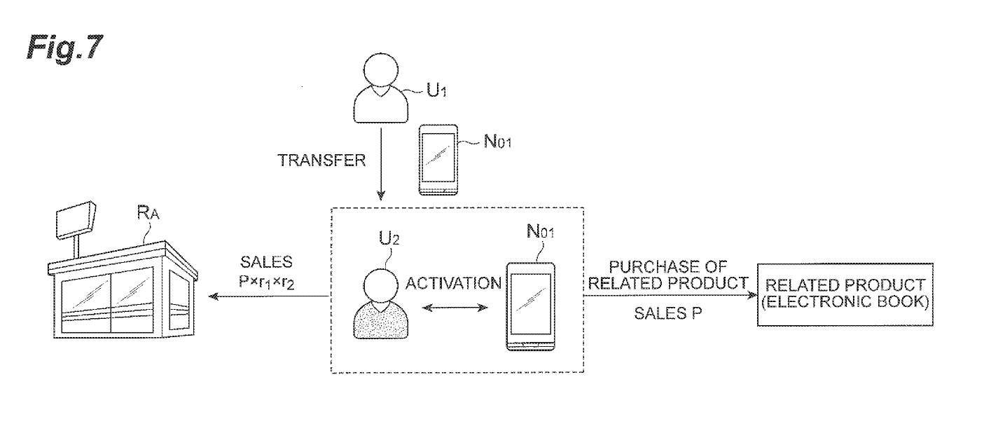

The calculation of remuneration based on the sales of an electronic book purchased after the transfer from an owner to whom a product has been sold first from a seller in the case where a terminal N is transferred between a plurality of owners is described hereinafter with reference to FIGS. 7 to 10.

FIG. 7 is a view showing an example of the calculation of remuneration based on the sales P of electronic books purchased when an owner U₂ owns a terminal N₀₁ after the terminal N₀₁ has been transferred from an owner U₁ to the owner U₂ and the owner U₂ has activated the terminal N₀₁. This example corresponds to the association information d₂ in FIG. 5. In the case shown in FIG. 7, the calculation unit 12 multiplies the sales P by the coefficient r₁ and a specified coefficient r₂ to calculate the remuneration “sales P×r₁×r₂” as remuneration to the seller R_{A} of the terminal N₀₁. The coefficient r₂ is set to a value less than 1, such as 0.9, for example. Specifically, based on the association information d₂, the calculation unit 12 calculates remuneration “36” to the seller “AAA” as shown in remuneration information f₂. In this manner, by multiplication of a specified coefficient in accordance with the number of transfers of the terminal N in the calculation of remuneration, it is possible to give a reasonable amount in accordance with the contribution to the sales of a related art as remuneration to the seller. Specifically, because the sales by the purchase of an electronic book by the owner U₂ includes the contribution by the transfer of the terminal N₀₁ from the owner U₁ to the owner U₂, an appropriate amount of remuneration in accordance with the contribution of the seller R_{A} from which the amount corresponding to the contribution of the owner U₁ is subtracted is calculated.

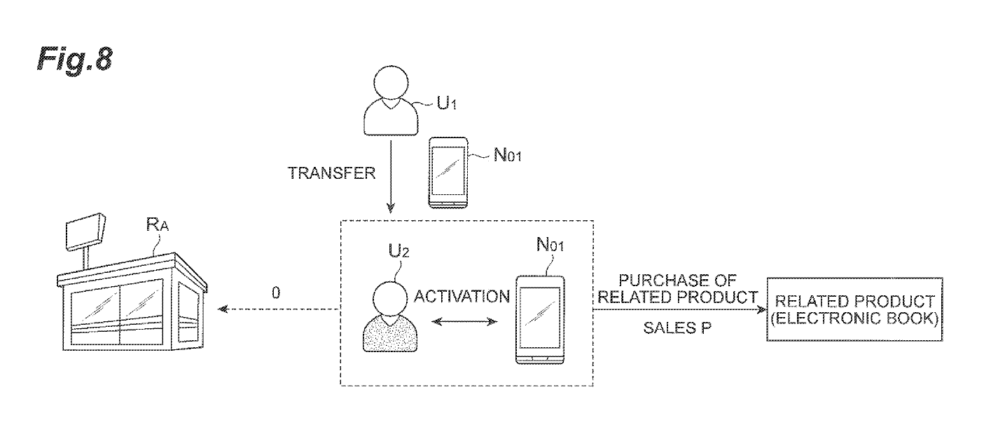

FIG. 8 is a view showing an alternative example which is different from the example shown in FIG. 7 in the calculation of remuneration. Specifically, FIG. 8 is a view showing an example of the calculation of remuneration based on the sales P of electronic books purchased when an owner U₂ owns a terminal N₀₁ after the terminal N₀₁ has been transferred from an owner U₁ who is the first owner of the terminal N₀₁ to the owner U₂ and the owner U₂ has activated the terminal N₀₁, and the calculated remuneration is different from the case of FIG. 7. In the case shown in FIG. 8, the calculation unit 12 sets the remuneration calculated based on the sales associated with an owner different from the first owner of the product to zero. This is done by setting the coefficient r₂ in the example shown in FIG. 7 to 0. To be specific, the calculation unit 12 calculates the remuneration “0” as remuneration to the seller R_{A} of the terminal N₀₁. Thus, in this case, it can be considered that the seller R_{A} does not contribute to the purchase of an electronic book by the owner U₂ different from the first owner U₁ of the terminal N₀₁. In this manner, because remuneration on the basis of the sales P that is associated with an owner different from the first owner of the terminal N is set to zero, the calculation of appropriate remuneration in view of the contribution of a seller in the selling of an electronic book is achieved.

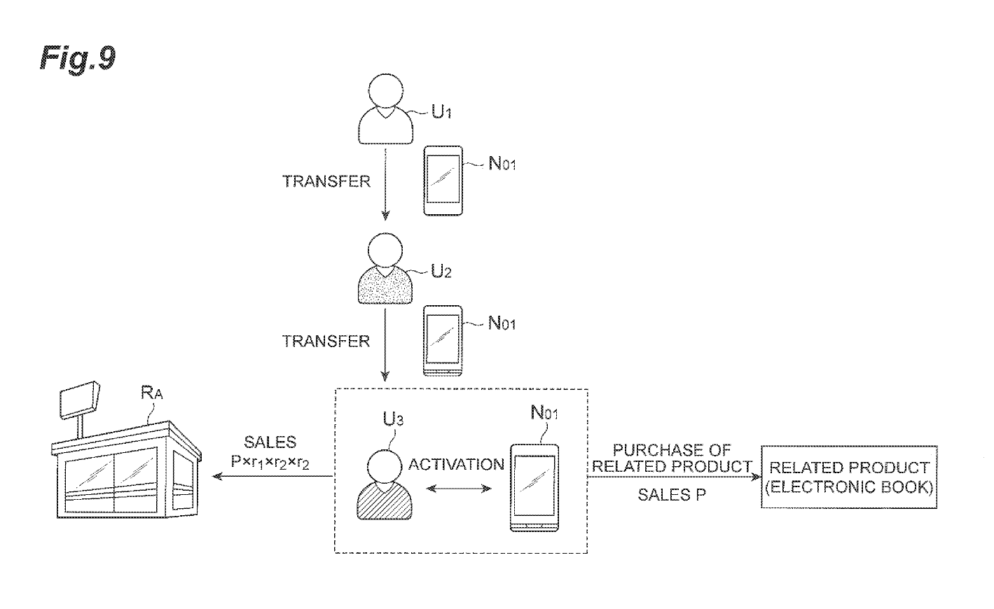

FIG. 9 is a view showing an example of the calculation of remuneration based on the sales P of electronic books purchased when an owner U₃ owns a terminal N₀₁ after the terminal N₀₁ has been transferred from an owner U₁ to an owner U₂, further transferred from the owner U₂ to the owner U₃, and the owner U₃ has activated the terminal N₀₁. This example corresponds to the association information d₃ in FIG. 5. In the case shown in FIG. 9, the calculation unit 12 multiplies the sales P by the coefficient r₁ and further multiplies it by a specified coefficient r₂ twice in accordance with the number of transfers to calculate the remuneration “sales P×r₁×r₂×r₂” as remuneration to the seller R_{A} of the terminal N₀₁. The coefficient r₂ is set to a value less than 1, such as 0.9, for example. Specifically, based on the association information d₃, the calculation unit 12 calculates the remuneration “81” to the seller “AAA” as shown in remuneration information f₃. In this manner, even when the transfer of the terminal N is repeated a plurality of times, by multiplication of a specified coefficient in accordance with the number of transfers of the terminal N in the calculation of remuneration, it is possible to give a reasonable amount in accordance with the contribution to the sales of a related art as remuneration to the seller. Specifically, because the sales by the purchase of an electronic book by the owner U₃ includes the contribution by the transfer of the terminal N₀₁ from the owner U₁ to the owner U₂ and the transfer of the terminal N₀₁ from the owner U₂ to the owner U₃, an appropriate amount of remuneration in accordance with the contribution of the seller R_{A} from which the amount corresponding to the contribution of the owner U₁ and the owner U₂ is subtracted is calculated. Note that, in place of the coefficient r₂ that is used for the multiplication in the second time, a coefficient less than 1 which is different from the coefficient r₂ may be used for the multiplication.

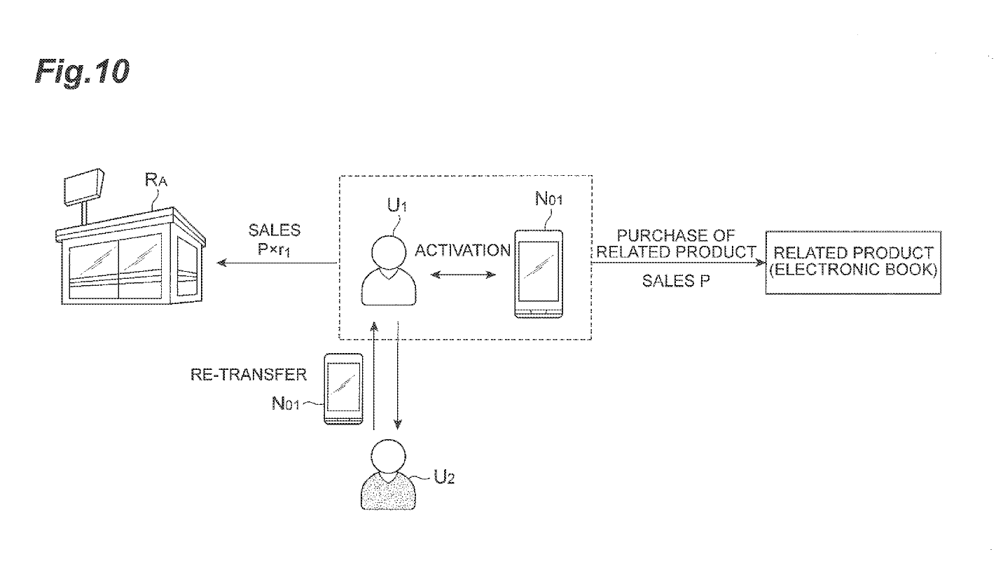

FIG. 10 is a view showing an alternative example which is different from the example shown in FIG. 9 in the calculation of remuneration. Specifically, FIG. 10 is a view showing an example of the calculation of remuneration based on the sales P of electronic books purchased when an owner U₁ owns a terminal N₀₁ after the terminal N₀₁ has been transferred from the owner U₁ who is the first owner of the terminal N₀₁ to an owner U₂ and further transferred to the owner U₁, and the owner U₁ has activated the terminal N₀₁. This example corresponds to the association information d₄ in FIG. 5. In the case shown in FIG. 10, the calculation unit 12 calculates remuneration based on the sales associated with the first owner who is a person having purchased the product from a seller. To be specific, the calculation unit 12 calculates the remuneration “sales P×r₁” as remuneration to the seller R_{A} of the terminal N₀₁. Because the number of transfers of the terminal is two, remuneration should be calculated by multiplication of the coefficient r₂ twice according to the example shown in FIG. 9; however, because the user “111” who owns the terminal N₀₁ by the transfer is the first owner who has purchased the terminal from the seller, remuneration is calculated by the expression “sales P×r₁”, as an exception to the case shown in FIG. 9. Specifically, based on the association information d₄, the calculation unit 12 calculates the remuneration “80” to the seller “AAA” as shown in remuneration information f₄. In this case, it can be considered that the seller R_{A} contributes to the purchase of an electronic book by the first owner of the terminal N₀₁. In this manner, when the terminal N₀₁ is transferred again to the first owner U₁ of the terminal N₀₁, remuneration is calculated based on the sales P that is associated with the owner U₁, and therefore the calculation of appropriate remuneration in view of the contribution of a seller in the selling of a product is achieved.

Further, the calculation unit 12 can calculate individual remuneration to be given to a seller of each terminal based on the entire remuneration on the basis of the sales of electronic books purchased during a period when a user owns a plurality of terminals. For example, when it is assumed that the individual remuneration is calculated by equally dividing the entire remuneration, based on the association information d₅ (FIG. 5), the calculation unit 12 multiplies the sales “1000” during the period when the user “111” owns the two terminals identified by the product identification information “N01” and “N02” by a specified coefficient “0.1” to calculate the entire remuneration “100”, and further multiplies the entire remuneration by the coefficient 0.5 to calculate the individual remuneration “50” to the sellers AAA and BBB of the respective terminals as shown in the remuneration information f₅.

Referring back to FIG. 2, the output unit 13 is a part that outputs remuneration information containing information related to the remuneration calculated by the calculation unit 12. For example, the output unit 13 outputs and stores the remuneration information into the remuneration information storage unit 32 which is a storage means for storing remuneration information. Another example of the output is display output for presenting the remuneration information to an administrator of the remuneration computation device 1. Then, remuneration is paid to each seller in accordance with the remuneration information.

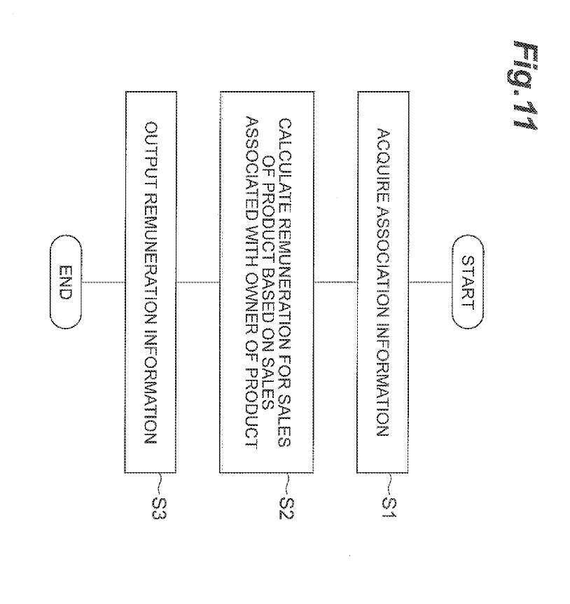

A remuneration computation method according to this embodiment is described hereinafter with reference to FIG. 11. FIG. 11 is a flowchart showing an example of a process of a remuneration computation method that calculates remuneration to be given to a seller of a product based on the sales of a related product which is purchased in relation to the product in the remuneration computation device 1 shown in FIG. 2.

First, the acquisition unit 11 acquires the association information in which the sales of a related product purchased during a period when an owner of a product owns the product, the owner who has purchased the related product, the product, and a seller of the product in association with one another (S1). Preferably, the acquisition unit 11 acquires the owner information, the sales information and the seller information and generates the association information.

Next, the calculation unit 12 calculates remuneration to be given to a seller associated with the terminal N based on the sales of electronic books associated with at least some of owners who owns the terminal N currently or who have owned the terminal N in the past (S2).

Then, the output unit 13 outputs remuneration information that contains information about the remuneration calculated by the calculation unit 12 (S3).

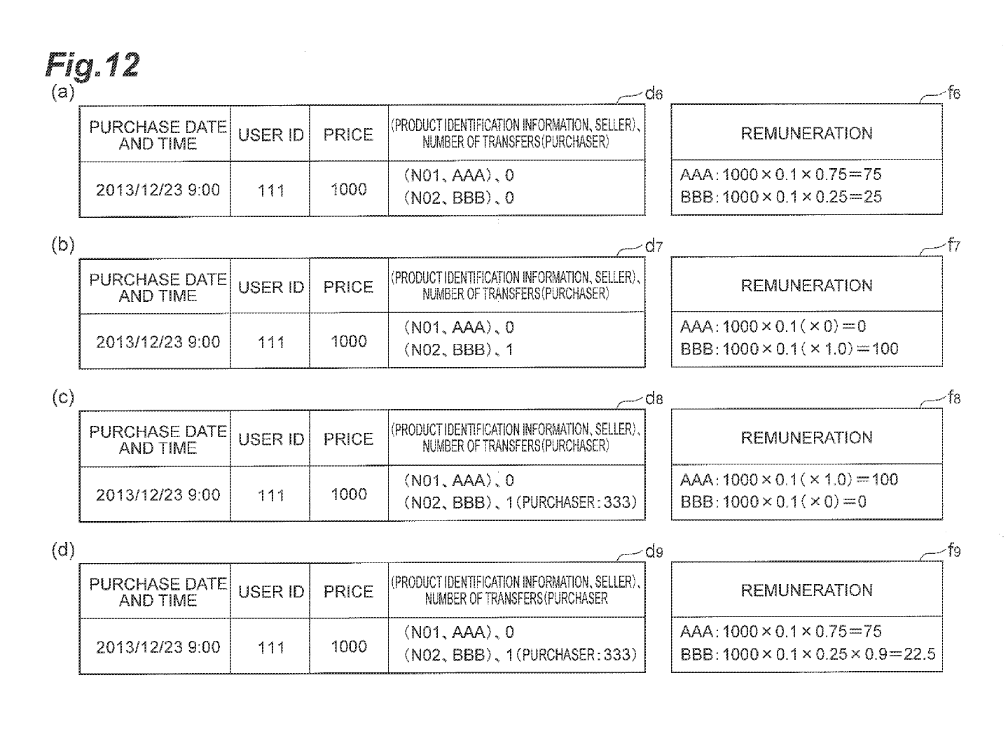

Hereinafter, the calculation of remuneration to each of sellers of a plurality of terminals N in the case where one owner owns the plurality of terminals N is described with reference to FIGS. 12 to 18. In the following example, the calculation unit 12 calculates individual remuneration to be given to each seller associated with at least some of a plurality of products in the seller information based on the entire remuneration on the basis of the sales of electronic books purchased during a period when an owner owns a plurality of terminals, the sales being associated with one owner in the sales information. Then, the output unit 13 outputs remuneration information that contains information about the individual remuneration to each of the sellers.

FIGS. 12(a) to 12(d) are views showing association information d₆ to d₉ generated by the acquisition unit 11 and remuneration information calculated based on those association information. Hereinafter, the calculation of remuneration to each the sellers of a plurality of terminals is described with reference to the association information and the remuneration information shown in FIGS. 12(a) to 12(d) and FIGS. 13 to 18.

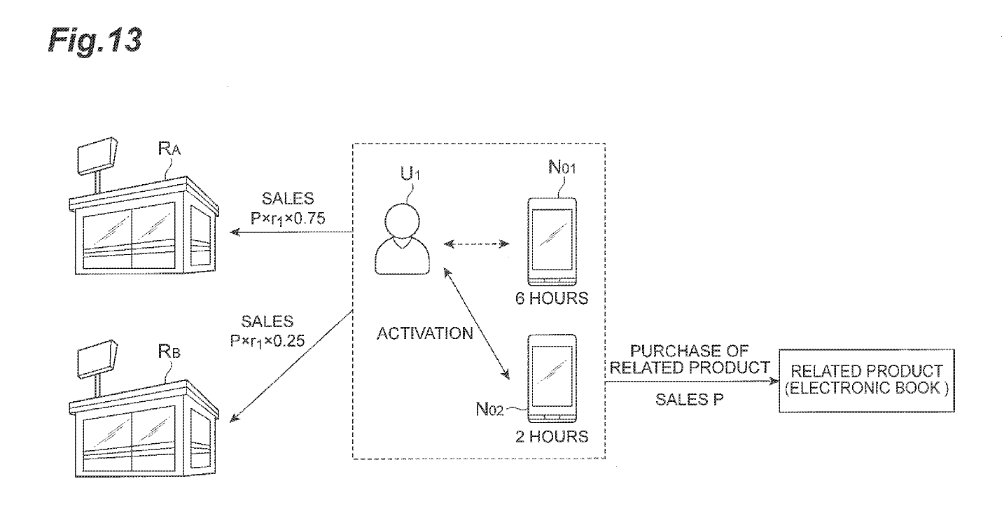

FIG. 13 is a view showing an example of the calculation of individual remuneration based on the sales P of electronic books purchased during a period when an owner U₁ (111) owns a terminal N₀₁ and a terminal N₀₂ after the owner U₁ who owns the terminal N₀₁ sold by a seller R_{A} (AAA) has activated the terminal N₀₂ sold by a seller R_{B} (BBB). The association information that is generated for the sales information related to the sales is shown in FIG. 12(a). In the example of FIG. 13, the owner U₁ uses the terminal N₀₁ for 6 hours in cumulative total and uses the terminal N₀₂ for 2 hours in cumulative total. Note that, because the period of time when the terminal N is used is stored in each terminal, data related to the cumulative use time of the terminal N can be acquired from each terminal by a server (for example, the product management device A) that manages the terminal N via a network, and the remuneration computation device 1 can refer to the data.

In such a case, the calculation unit 12 multiplies the sales P by the coefficient r₁ to calculate the entire remuneration “sales P×r₁”. Then, the calculation unit 12 calculates the individual remuneration to be given to each seller R associated with each of the plurality of terminals N based on the use status of the plurality of terminals N. Specifically, the calculation unit 12 multiplies the entire remuneration “sales P×r₁” by the proportion of the cumulative time of using each of the terminal N₀₁ and the terminal N₀₂ to calculate the individual remuneration “sales P×r₁×0.75” to the seller R_{A} and the individual remuneration “sales P×r₁×0.25” to the seller R_{B}. To be specific, the calculation unit 12 calculates the individual remuneration 75 (1000×0.1×0.75) to the seller R_{A} and the individual remuneration 25 (1000×0.1×0.25) to the seller R_{B} as shown in the remuneration information f₆ based on the association information d₆ in FIG. 12(a). In this manner, because the individual remuneration to each seller is calculated in accordance with the use status of a plurality of terminals, it is possible to adjust the remuneration to sellers of the plurality of terminals to reasonable values in view of the contribution of each of the sellers. Particularly, in the example shown in FIG. 13, because the individual remuneration is calculated based on the cumulative time of use of each terminal, adequate individual remuneration to each of sellers of a plurality of terminals is calculated.

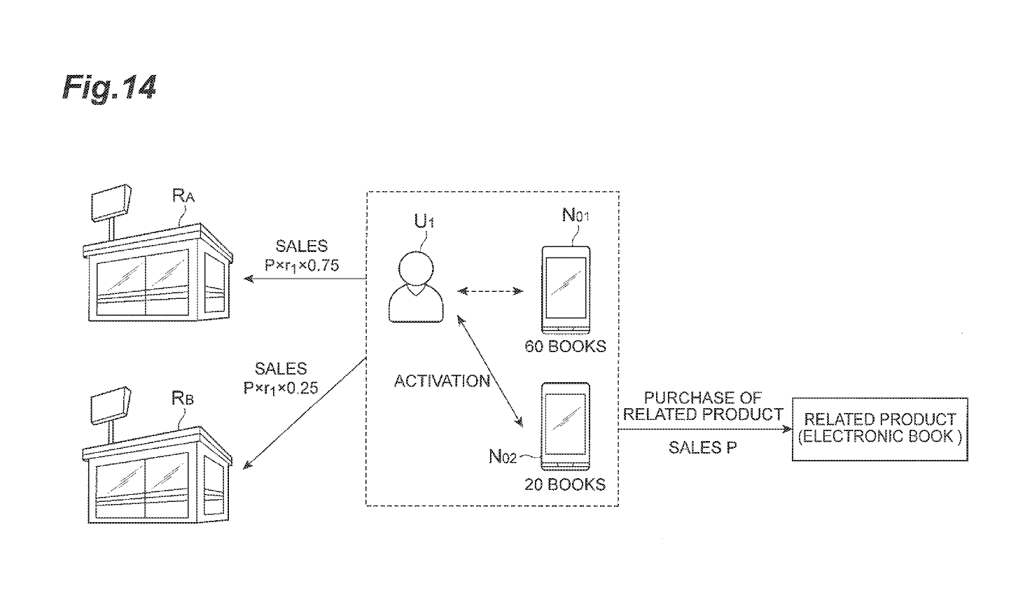

FIG. 14 is a view showing an example of calculating the individual remuneration based on the number of electronic books stored in each terminal, instead of calculating the individual remuneration based on the cumulative time of use of each terminal in the example shown in FIG. 13. In this example, an owner U₁ stores 60 electronic books in a terminal N₀₁ and stores 20 electronic books in a terminal N₀₂. The example shown in FIG. 14 corresponds to the association information d₆ shown in FIG. 12(a). Note that data related to the number of electronic books stored in the terminal N can be acquired from each terminal by a server (for example, the product management device A) that manages the terminal N via a network, and the remuneration computation device 1 can refer to the data.

In such a case, the calculation unit 12 multiplies the sales P by the coefficient r₁ to calculate the entire remuneration “sales P×r₁”. Then, the calculation unit 12 multiplies the entire remuneration “sales P×r₁” by the proportion of the number of electronic books stored in each of the terminal N₀₁ and the terminal N₀₂ to calculate the individual remuneration “sales P×r₁×0.75” to the seller R_{A} and the individual remuneration “sales P×r₁×0.25” to the seller R_{B}. To be specific, the calculation unit 12 calculates the individual remuneration 75 (1000×0.1×0.75) to the seller R_{A} and the individual remuneration 25 (1000×0.1×0.25) to the seller R_{B} as shown in the remuneration information f₆ based on the association information d₆ in FIG. 12(a). In this manner, because the individual remuneration is calculated based on the number of electronic books stored in each terminal, adequate individual remuneration to each of sellers of a plurality of terminals is calculated.

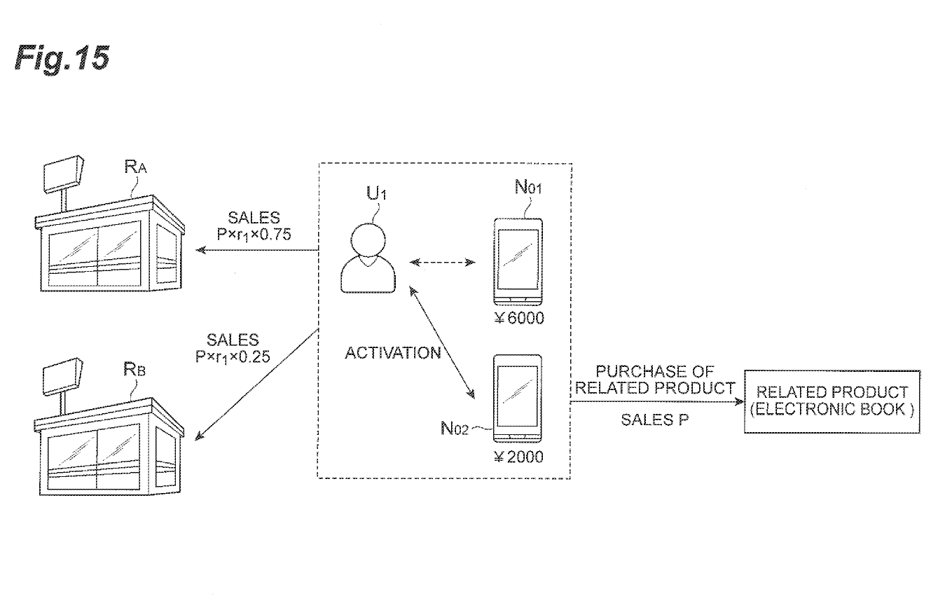

FIG. 15 is a view showing an example of calculating the individual remuneration based on the total price of electronic books stored in each terminal, instead of calculating the individual remuneration based on the cumulative time of use of each terminal in the example shown in FIG. 13. In this example, the total price of electronic books stored in a terminal N₀₁ is 6000 yen, and the total price of electronic books stored in a terminal N₀₂ is 2000 yen. The example shown in FIG. 15 corresponds to the association information d₆ shown in FIG. 12(a). Note that, because the remuneration computation device 1 can refer to data related to the electronic books stored in the terminal N as described above, the total price of electronic books stored in the terminal can be acquired by a known technique such as adding up the prices of the electronic books based on the data.

In such a case, the calculation unit 12 multiplies the sales P by the coefficient r₁ to calculate the entire remuneration “sales P×r₁”. Then, the calculation unit 12 multiplies the entire remuneration “sales P×r₁” by the proportion of the total price of electronic books stored in each of the terminal N₀₁ and the terminal N₀₂ to calculate the individual remuneration “sales P×r₁×0.75” to the seller R_{A} and the individual remuneration “sales P×r₁×0.25” to the seller R_{B}. To be specific, the calculation unit 12 calculates the individual remuneration 75 (1000×0.1×0.75) to the seller R_{A} and the individual remuneration 25 (1000×0.1×0.25) to the seller R_{B} as shown in the remuneration information f₆ based on the association information d₆ in FIG. 12(a). In this manner, because the individual remuneration is calculated based on the total price of related products stored in each terminal, adequate individual remuneration to each of sellers of a plurality of terminals is calculated.

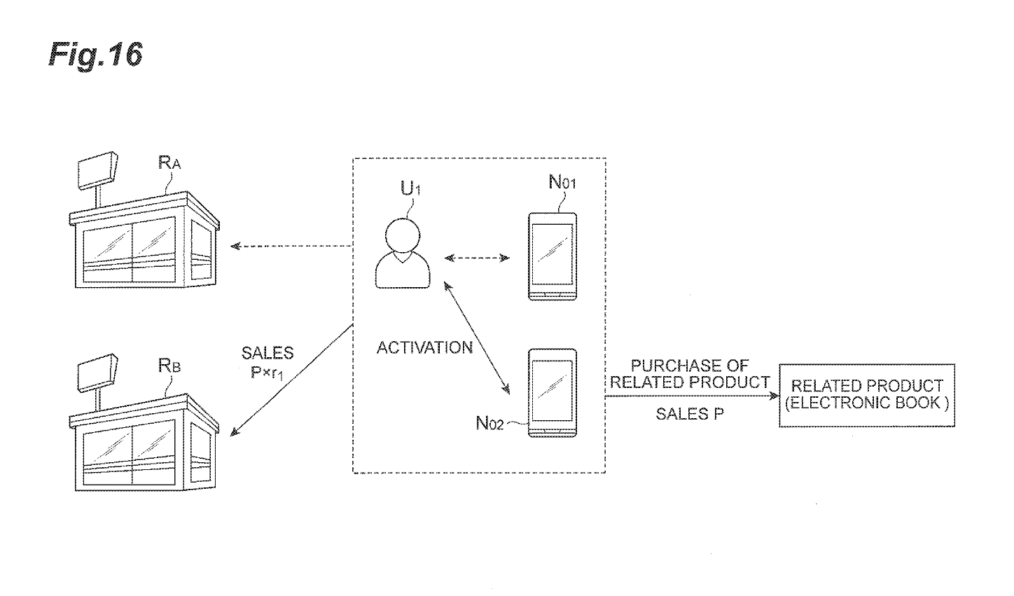

FIG. 16 is a view showing an example of the calculation of individual remuneration based on the sales P of electronic books purchased during a period when an owner U₁ owns a terminal N₀₁ and a terminal N₀₂ after the owner U₁ who owns the terminal N₀₁ sold by a seller R_{A} (AAA) has activated a terminal N₀₁ sold by a seller R_{B} (BBB). The association information that is generated for the sales information related to the sales is shown in FIG. 12(a). In the example of FIG. 16, the calculation unit 12 multiplies the sales P by the coefficient r₁ to calculate the entire remuneration “sales P×r₁”. Then, the calculation unit 12 gives all of the entire remuneration as the individual remuneration “sales P×r₁” to the seller R_{B} of the terminal N₀₂ activated by the owner U₁ most recently among the plurality of terminals owned by the owner U₁. To be specific, the calculation unit 12 calculates the individual remuneration 0 (1000×0.1×0) to the seller R_{A} and the individual remuneration 100 (1000×0.1×1.0) to the seller R_{B} as shown in the remuneration information f₇ based on the association information d₇ in FIG. 12(b). In other words, while the entire remuneration is distributed to a plurality of sellers with a specified proportion in the examples of FIGS. 13 to 15, 100% of the entire remuneration is given as the individual remuneration to the seller of a terminal activated most recently, and 0% of the entire remuneration is set as the individual remuneration to the other sellers. In this manner, because the individual remuneration is calculated based on the assumption that the seller of a terminal activated by an owner most recently among a plurality of terminals contributes to the purchase of an electronic book by the owner, the calculation of individual remuneration is easy.

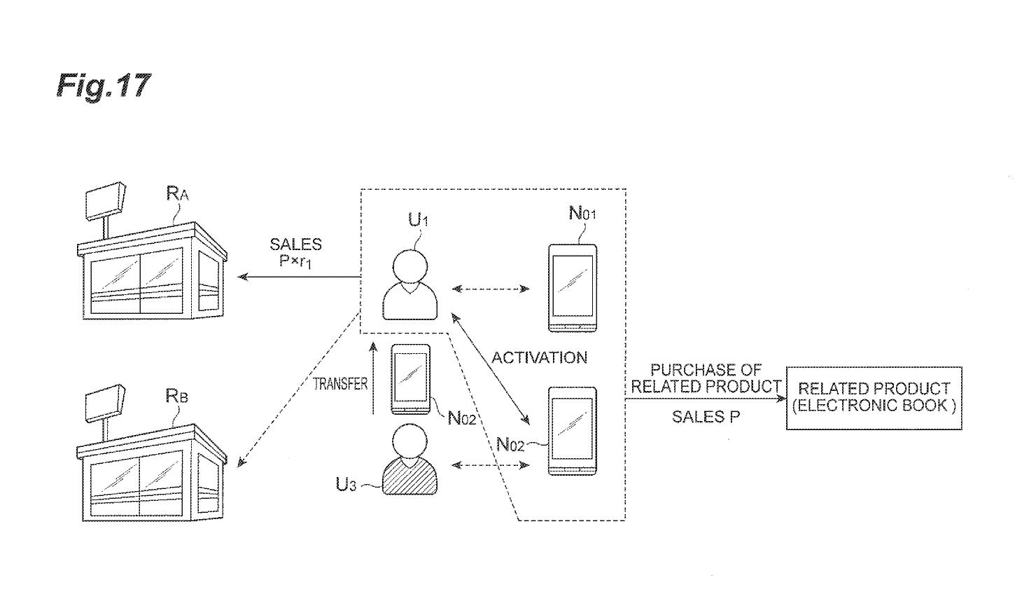

FIG. 17 is a view showing an example of the calculation of individual remuneration based on the sales P of electronic books purchased during a period when an owner U₁ owns a terminal N₀₁ and a terminal N₀₂ after the owner U₁ who owns the terminal N₀₁ sold by a seller R_{A} has acquired by transfer and activated the terminal N₀₂ sold by a seller R_{B} to an owner U₃ (333) and activated by the owner U₃. The association information that is generated for the sales information related to the sales is shown in FIG. 12(c). In the example of FIG. 17, the calculation unit 12 multiplies the sales P by the coefficient r₁ to calculate the entire remuneration “sales P×r₁”. Then, the calculation unit 12 gives all of the entire remuneration as the individual remuneration “sales P×r₁” to the seller R_{A} of the terminal N₀₁ purchased from the seller and activated by the owner U₁ among the plurality of terminals owned by the owner U₁. To be specific, the calculation unit 12 calculates the individual remuneration 100 (1000×0.1×1.0) to the seller R_{A} and the individual remuneration 0 (1000×0.1×0) to the seller R_{B} as shown in the remuneration information f₈ based on the association information d₈ in FIG. 12(c). In other words, the example of FIG. 17 is an exception to the example of FIG. 16, and when a user who owns a terminal further acquires a terminal that has been owned by another person and purchases an electronic book during a period when the user owns the plurality of terminals, the remuneration on the basis of the purchase is not given to the seller of the terminal acquired from another person but given to the seller of the terminal already owned, and to be more specific, 100% of the entire remuneration is given as the individual remuneration to the seller of the terminal purchased from the seller and activated by the owner, and 0% of the entire remuneration is set as the individual remuneration to the seller of the terminal acquired by the transfer. In this manner, because all of the entire remuneration is given as the individual remuneration to a seller of a terminal purchased from the seller and activated by an owner among a plurality of terminals based on the assumption that the seller of a terminal does not contribute to the purchase of an electronic book by an owner different from the firs owner of the terminal, the calculation of individual remuneration is easy.

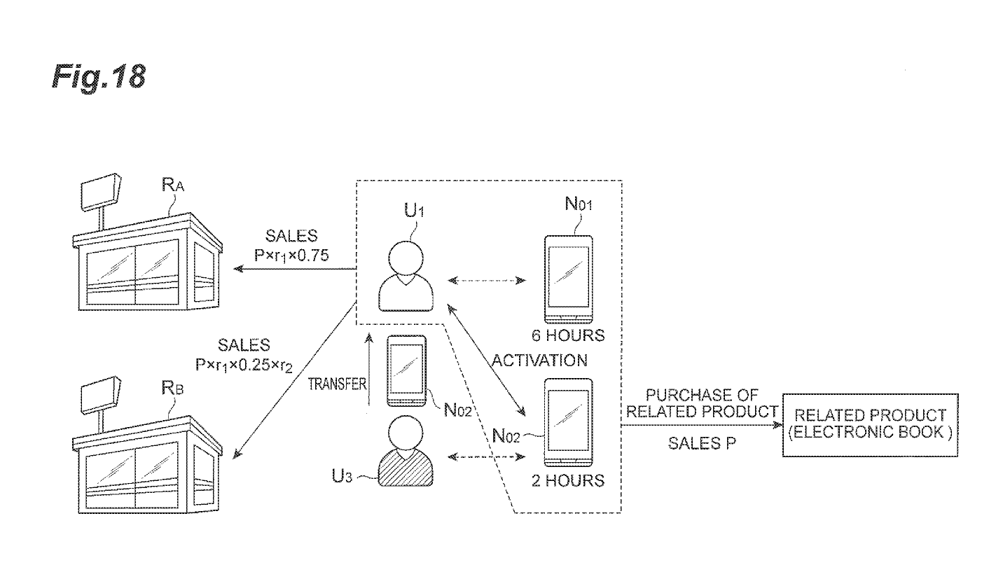

FIG. 18 is a view showing an example of the calculation of individual remuneration based on the sales P of electronic books purchased during a period when an owner U₁ owns a terminal N₀₁ and a terminal N₀₂ after the owner U₁ who owns the terminal N₀₁ sold by a seller R_{A} has acquired by transfer and activated the terminal N₀₂ sold by a seller R_{B} to an owner U₃ (333) and activated by the owner U₃. In this example, the owner U₁ uses the terminal N₀₁ for 6 hours in cumulative total and uses the terminal N₀₂ for 2 hours in cumulative total. The association information that is generated for the sales information related to the sales is shown in FIG. 12(d).

In the example of FIG. 18, the calculation unit 12 multiplies the sales P by the coefficient r₁ to calculate the entire remuneration “sales P×r₁”. Then, when the terminal N₀₂ among the plurality of terminals N owned by the owner U₁ is transferred from another owner, the calculation unit 12 distributes and gives the entire remuneration as the individual remuneration to each seller R associated with each of the plurality of terminals N. To be specific, the calculation unit 12 multiplies the entire remuneration “sales P×r₁” by the proportion of the cumulative time of using each of the terminal N₀₁ and the terminal N₀₂ to calculate the individual remuneration “sales P×r₁×0.75” to the seller R_{A} and the individual remuneration “sales P×r₁×0.25” to the seller R_{B}.

Further, in the calculation of individual remuneration to the seller R_{B}, the calculation unit 12 multiplies it by a specified coefficient r₂ in accordance with the number of transfers of the terminal N₀₂ associated with the seller R_{B} to calculate the individual remuneration “sales P×r₁×0.25×r₂”. The value of r₂ may be 0.9, for example.

To be specific, the calculation unit 12 calculates the individual remuneration 75 (1000×0.1×0.75) to the seller R_{A} and the individual remuneration 22.5 (1000×0.1×0.25×0.9) to the seller R_{B} as shown in the remuneration information f₉ based on the association information d₉ in FIG. 12(d). In other words, the technical idea in the calculation of remuneration in FIG. 18 is the application of the technical idea in the calculation of remuneration in FIG. 7 to the technical idea in the calculation of remuneration in FIG. 13. In this manner, because the individual remuneration to the seller R of each terminal N is calculated based on the sales of electronic books purchased during a period when an owner owns a plurality of terminals N including a terminal N transferred from another owner, it is possible to give an incentive for the sales of the terminal N to each seller R. Further, because the amount reduced in accordance with the number of transfers of the terminal N can be set as the individual remuneration to each seller R, it is possible to give adequate amount in accordance with the contribution to the sales of electronic books as remuneration to the seller R.

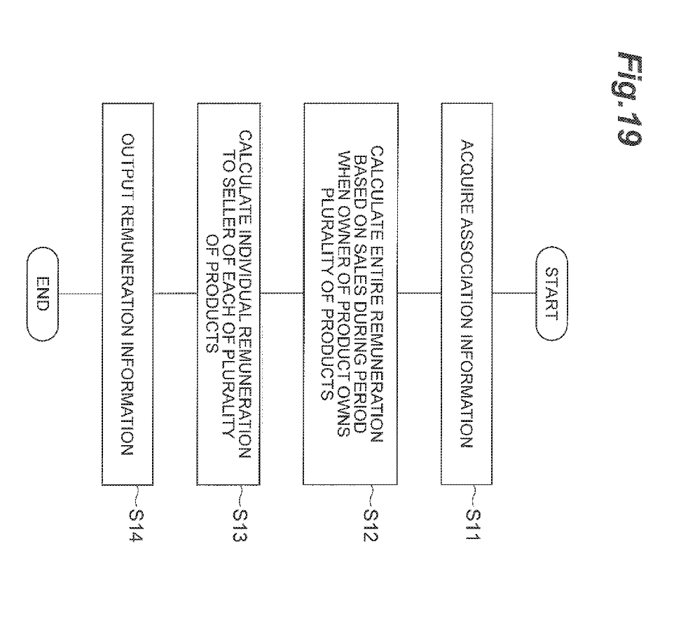

A remuneration computation method according to this embodiment is described hereinafter with reference to FIG. 19. FIG. 19 is a flowchart showing an example of a process of a remuneration computation method that calculates individual remuneration to each of sellers of a plurality of terminals N when one owner owns the plurality of terminals N in the remuneration computation device 1 shown in FIG. 2.

First, the acquisition unit 11 acquires the association information in which the sales of a related product purchased during a period when an owner of a product owns the product, the owner who has purchased the related product, the product, and a seller of the product in association with one another (S11). Preferably, the acquisition unit 11 acquires the owner information, the sales information and the seller information and generates the association information.

Next, the calculation unit 12 calculates the entire remuneration for the sales based on the sales of electronic books (related products) purchased during a period when an owner U owns a plurality of terminals N (products) (S12). Then, based on the entire remuneration, the calculation unit 12 calculates the individual remuneration to be given to each seller associated with at least some of a plurality of products in the seller information (S13).

Then, the output unit 13 outputs remuneration information that contains information about the individual remuneration calculated by the calculation unit 12 (S14).

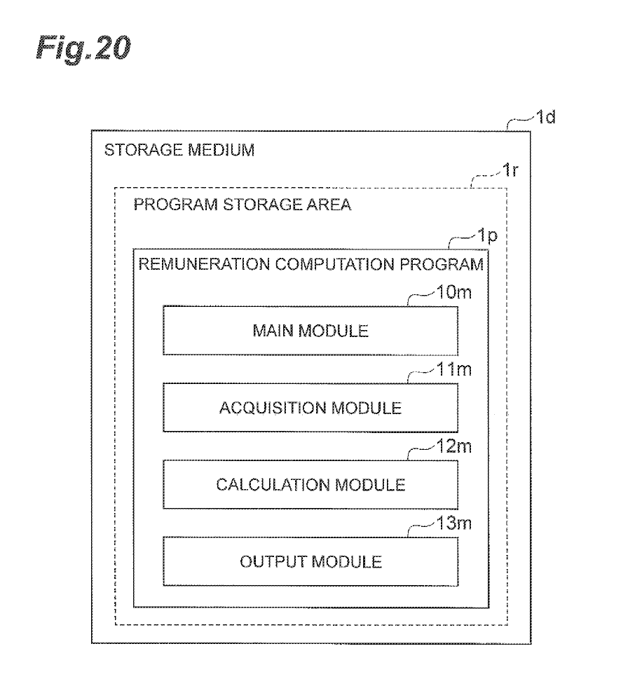

A remuneration computation program that causes a computer to function as the remuneration computation device 1 is described hereinafter with reference to FIG. 20. A remuneration computation program 1p includes a main module 10m, an acquisition module 11m, a calculation module 12m, and an output module 13m.

The main module 10m is a part that exercises control over the remuneration computation processing. The functions implemented by executing the acquisition module 11m, the calculation module 12m and the output module 13m are respectively the same as the functions of the acquisition unit 11, the calculation unit 12 and the output unit 13 of the remuneration computation device 1 shown in FIG. 2.

The remuneration computation program 1p is provided through a storage medium 1d such as CD-ROM or DVD-ROM or semiconductor memory, for example. Further, the remuneration computation program 1p may be provided as a computer data signal superimposed onto a carrier wave over a communication network.

According to the remuneration computation device 1, the remuneration computation method and the remuneration computation program 1p of this embodiment described above, based on the sales of electronic books purchased by an owner U who owns a terminal N by transfer, remuneration to a seller of the terminal N is calculated. Then, the calculated remuneration can be paid to the seller R as promotion money. Thus, the promotion money acts as an incentive for the sales of the terminal N by the seller R, and it is thus possible to promote the sales of the terminal N. Further, based on the sales of electronic books purchased during a period when an owner U owns a plurality of terminals N, individual remuneration to a seller R of each of the terminals is calculated. Then, the calculated individual remuneration can be paid to each seller R as promotion money. Thus, the promotion money acts as an incentive for the sales of the terminal N by each seller R, and it is thus possible to promote the sales of the terminal N.

An embodiment of the present invention is described in detail above. However, the present invention is not limited to the above-described embodiment. Various changes and modifications may be made to the present invention without departing from the scope of the invention.

### REFERENCE SIGNS LIST

1 . . . remuneration computation device, 11 . . . acquisition unit, 12 . . . calculation unit, 13 . . . output unit, 21 . . . seller information storage unit, 22 . . . owner information storage unit, 23 . . . sales information storage unit, 31 . . . association information storage unit, 32 . . . remuneration information storage unit, A . . . product management device, B . . . related product selling device, 100 . . . remuneration computation system, 1d . . . storage medium, 1p . . . remuneration computation program, 10m . . . main module, 11m . . . acquisition module, 12m . . . calculation module, 13m . . . output module, N . . . terminal, R,R_{A},R_{B} . . . seller, U,U₁,U₂,U₃ . . . owner

1. A remuneration computer architecture for calculating remuneration to be given to a seller of a product, comprising:
at least one memory configured to store computer program code;
at least one processor configured to access said memory, read said computer program code, and operate according to said computer program code, said computer program code including:
acquisition code configured to cause at least one of said at least one processor to acquire association information where a seller of a product, the product, an owner of the product, and sales of a related product purchased during a period when the owner owns the product, the related product to be purchased in relation to the product, are associated;
calculation code configured to cause at least one of said at least one processor to calculate remuneration to be given to a seller of the product based on sales associated with at least some of owners who own the product after transfer of the product from an owner to whom the product has been sold first by a seller, the seller to whom the remuneration is to be given being specified based on the association information where a product owned by the owner associated with the sales when purchasing the related product relevant to the sales and the seller of the product are associated; and
output code configured to cause at least one of said at least one processor to output remuneration information containing information about the remuneration.

2. The remuneration computer architecture according to claim 1, wherein
the acquisition code is configured to cause at least one of said at least one processor to acquire seller information where the product and a seller of the product are associated, owner information where the product and an owner of the product are associated, and sales information where an owner and sales of a related product purchased by the owner are associated, and generate the association information based on the acquired seller information, owner information and sales information.

3. The remuneration computer architecture according to claim 1, wherein
in calculation of the remuneration on the basis of the sales, the calculation code causes at least one of said at least one processor to reduce a proportion of the remuneration to the sales in accordance with the number of transfers of the product at purchase or transfer of the product.

4. The remuneration computer architecture according to claim 1, wherein
in calculation of the remuneration on the basis of the sales, when another product different from the product is owned, the calculation code cause at least one of said at least one processor to calculate, as the remuneration, individual remuneration to be given to a seller of the product based on entire remuneration on the basis of the sales.

5. A remuneration computation method in a remuneration computation device for calculating remuneration to be given to a seller of a product, comprising:
acquiring association information where a seller of a product, the product, an owner of the product, and sales of a related product purchased during a period when the owner owns the product, the related product to be purchased in relation to the product, are associated;
calculating remuneration to be given to a seller of the product based on sales associated with at least some of owners who own the product after transfer of the product from an owner to whom the product has been sold first by a seller, the seller to whom the remuneration is to be given being specified based on the association information where a product owned by the owner associated with the sales when purchasing the related product relevant to the sales and the seller of the product are associated; and
outputting remuneration information containing information about the remuneration.

6. A non-transitory computer-readable recording medium storing a remuneration computation program causing a computer to function as a remuneration computation device for calculating remuneration to be given to a seller of a product, the program causing the computer to:
acquire association information where a seller of a product, the product, an owner of the product, and sales of a related product purchased during a period when the owner owns the product, the related product to be purchased in relation to the product, are associated;
calculate remuneration to be given to a seller of the product based on sales associated with at least some of owners who own the product after transfer of the product from an owner to whom the product has been sold first by a seller, the seller to whom the remuneration is to be given being specified based on the association information where a product owned by the owner associated with the sales when purchasing the related product relevant to the sales and the seller of the product are associated; and
output remuneration information containing information about the remuneration.

7.-15. (canceled)
